(19) United States
(12) Patent Application Publication
(10) Pub. No.: US 2007/0053006 A1
(43) Pub. Date: Mar. 8, 2007

(54) Electronic Host (E-host)

(76) Inventor: LINCOLN MURINGAYI, ORLANDO, FL (US)

Correspondence Address: LINCOLN MURINGAYL, 1689 S. KIRKMAN RD., # 335, ORLANDO, FL, 32811-2226, US

(21) Appl. No.: 11/161,971

(22) Filed: Aug. 24, 2005

(51) Int. Cl. H04N 1/00

(52) U.S. Cl. 358/402

(57) ABSTRACT

Electronic Host. The E-host combines a programmed chip, circuit, power source and Light Emitting Diodes to sequence lighting in different colors for periods specified in the chip programming. The E-host exists to easily assist diners or any other seated individuals who may need assistance without lengthy waits or searches. The internal chip controls the color/s emitted from the internally positioned diodes and the length for which each color is emitted. There is no lighting device presently available, in seated situations, which lets the seated individual/diner turn on and allow a server to identify that assistance is required and how long it has been required, by means of changing the emitted color.

### BACKGROUND OF THE INVENTION

The E-host is a compact device for use mainly in restaurants and bars to more easily request attention from a server or steward. It can also be used in any situation where people are seated and need to request the assistance of an individual whose job it is to provide such help. Seated individuals sometimes have to wait long periods before they can attract the attention of a server or helper for assistance. Research suggests that over 60% or restaurant diners are negatively affected when they cannot get immediate attention from a server or steward.

The E-host is a compact device that embodies LED (light emitting diode) technology. An internal circuit including a programmable chip shall be programmed to control the LED function including the color of light emitted. The E-host uses LEDs to emit light and thus attract attention when service is required.

### BRIEF SUMMARY OF THE INVENTION

The E-host will be a compact device attached to or close to the edge of a table. When turned on by means of pressing a small switch, the enclosed LED will light up and shine through an acrylic/plastic window. The device may contain more than a single LED. An important aspect of this device is its use of more than one color in a light sequence to indicate wait time. For example; when the device is turned on, the light coming out through the window may be white. After two minutes, the light shining from within the device might change to green to indicate that assistance has been required at that table for at least two minutes. The light may also then turn to red after an additional two minutes to indicate that the total wait time at that table has been at least four minutes. Upon seeing the light come on, not only will a server or helper become aware that individuals at that particular table require assistance but also how long they have been waiting. For seated guests, it will eliminate wait time and continuously seeking out servers.

### BRIEF DESCRIPTION OF THE DRAWINGS

FIG. 1a shows the 3D graphic depiction of the E-host. The on/off switch is used to turn the device on and off. Attachment screws help to attach the device to a table by fastening the table attachment to the underneath of the table. The fastening screws on the front of the device only serve to maintain the structural integrity of the E-host's casing. The acrylic window assists in diffusing the light produced internally by the LED.

FIG. 1b shows the preferred attachment method of the E-host to the table so that, except for the on/off switch, very little of the rest of the device protrudes over the table's top edge.

FIG. 2 shows the internal working components of the E-host. The on/off switch and mechanism serve to turn on the device when the switch is pressed. The power source, which may be AC or DC, supplies an electrical current to the circuit allowing it to become active and the LED to turn on. The circuit board will connect all the components of the device to function as a single system. The program chip contains the data, which will govern the actions of the LED. It will govern what color LED will turn on at a particular time and the length of time it will stay on. FIG. 2 also shows the approximate dimensions of the E-host.

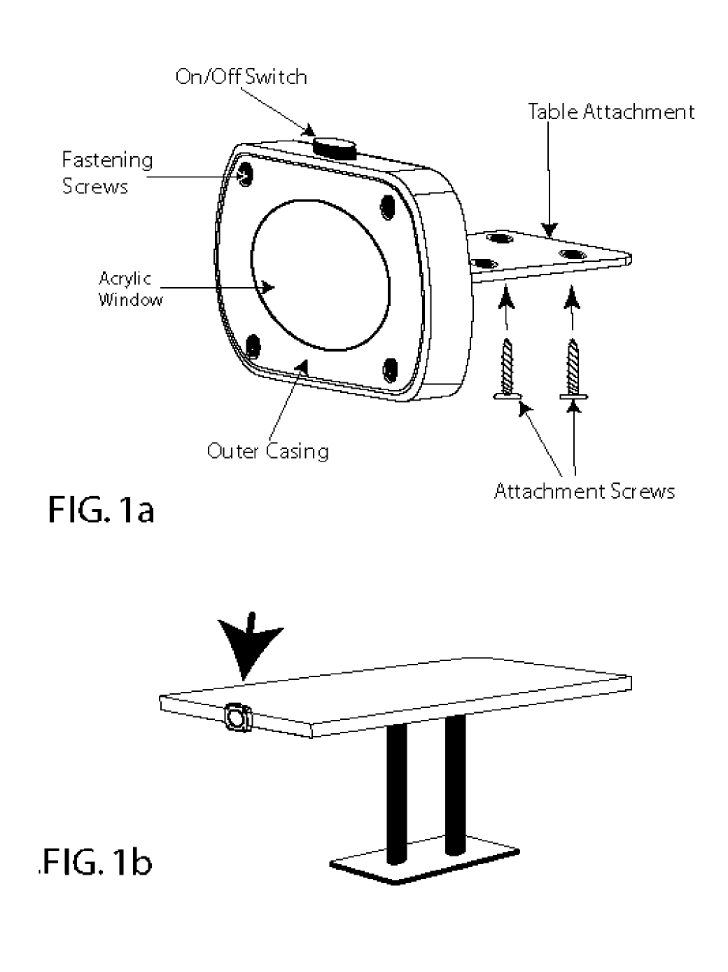

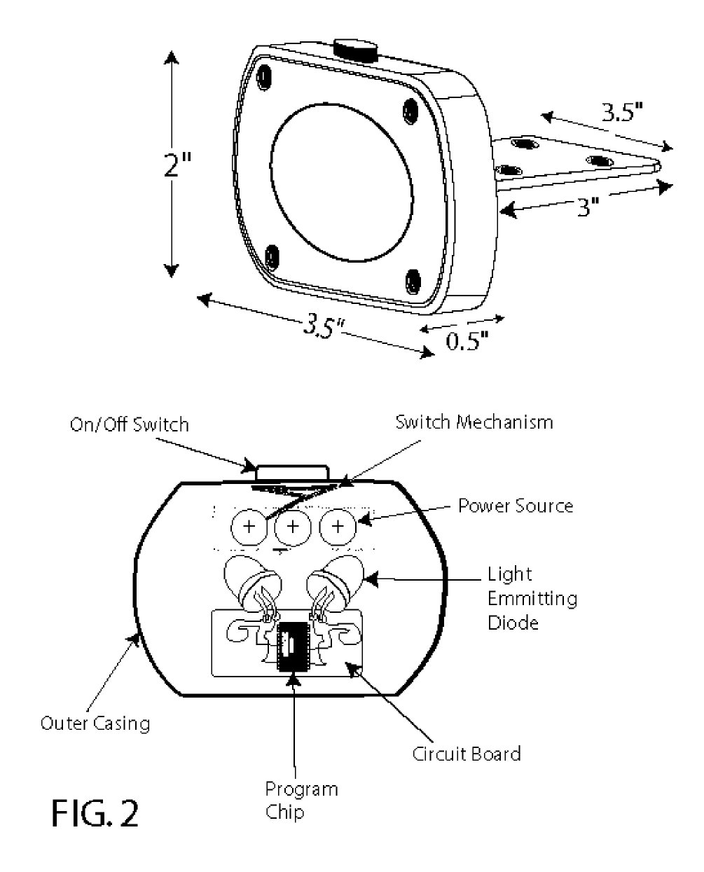

### DETAILED DESCRIPTION OF THE INVENTION

The casing of the device will be made of ABS or any metal alloy. To achieve the desired shape, a mold must be created which will give the molten alloy or plastic polymer its shape on cooling. For the acrylic window on the front of the E-host, a mold must also be created to achieve the desired shape. The window diffuses the light produced so a person looking at the device from a short distance may easily see it. The on/off switch may be ABS or any metal alloy and is also created by using a mold. The switch must be spring loaded when attached to the casing allowing it to re-emerge when depressed. The spring loading system should preferably, also be the switch mechanism and extend down to the power source circuit. When depressed, the switch mechanism should cause the power source circuit to become complete and send an electric current to the circuit board, which lights up the LED. The power source can be a series of batteries or an AC current wired into the device from an external source.

The role of the circuit board in the device is to connect all internal components and re-route the electric current from the power source to the LED. The pattern or circuit on the circuit board may be created by direct copper plating on a blank board or etching, the process that involves chemically removing the unwanted copper from a plated board. The circuit board also holds the program chip. The chip is programmed to control all aspects of the lighting function of the LED/s including;
a. Which color LED is to come on.
b. When an LED is to come on.
c. How long the LED will stay on.
d. When the LED should turn off.
e. In the case where one RGB (red, green, blue) LED bulb is used, it will also control the color emitted and the length of time it remains lit.

When all the internal components are assembled and enclosed in the casing, the E-host will be attached to a table, preferably, by means of screws bolted to the underneath of the table using the table attachment (as in diagram 1a). For example; when the switch is pressed, this activates the E-host. A white light will shine through the acrylic window for two minutes. If the switch has not been pressed again to turn off the device after that time length, the light will turn to green for an additional two minutes. If the switch, still, has not been pressed again to turn off the device after the 4 minute length, the light will turn to red and remain that color until the device is eventually turned off. At any stage, pressing the switch can turn off the device. When turned on again, the device will start again by emitting the first color in the programmed sequence. The color sequence serves to alert an individual serving that table of how long the light has been on or how long the seated individuals have needed assistance.

What is claimed is:

1. This is the first compact device that;
a. Can be attached to a restaurant/bar or other table for seated individuals' use to request service AND,
b. Has color changing ability to request service and also indicate the amount of time such service has been required AND,
c. Incorporates the use of an internal circuit and programmable chip to control the lighting and lighting sequence AND,
d. Incorporates the use of LEDs (Light Emitting Diodes) to produce the required light through a diffuser window
No specific claims are made with regard to the Outer casing, Table attachment, Switch, Switch mechanism, Acrylic window, Power source, Circuit board, Programmable chip, LED; for the following:
a. Material compositions
b. Dimensions
c. Shapes and colors
d. Surface decorations
e. When more than one, how many of each component may be used in constructing the device
f. Each component's position in the device
No specific claims are made with regard to the LEDs, for the following:
a. When more than one, how many may be used in constructing the device
b. The actual colors and color sequence when turned on
c. The period that each color remains lit
d. The light intensity.
